(19) United States
(12) Patent Application Publication
(10) Pub. No.: US 2009/0287794 A1
(43) Pub. Date: Nov. 19, 2009

(54) Assisting media servers in determining media profiles

(75) Inventors: Mika Saaranen, Pirkkala (FI); Antti Tapiola, Kisko (FI)

Correspondence Address: Hollingsworth & Funk, 8500 Normandale Lake Blvd., Suite 320, Minneapolis, MN, 55437, US

(73) Assignee: Nokia Corporation and Recordation

(21) Appl. No.: 12/152,806

(22) Filed: May 16, 2008

(51) Int. Cl. G06F 15/16

(52) U.S. Cl. 709/219

(57) ABSTRACT

Assisting media servers to determine profiles of locally served media objects involves enumerating digital media objects on a media server device. A remote procedure call of a network server is invoked to determine the media profile identifiers. Sample portions of the digital media objects are accessed, and the sample portions are usable to assign media profile identifiers to the respective digital media objects. The sample portions of the digital media objects are sent to the network server. In response to invoking the remote procedure call, the media server device receives the media profile identifiers assigned to the sample portions from the network server. The media profile identifiers are assigned to the digital media objects at the media server device based on the assignment of the media profile identifiers to the sample portions.

### FIELD OF THE INVENTION

This invention relates in general to computer networks, and more particularly to digital media sharing/utilization in home networks.

### BACKGROUND OF THE INVENTION

Recently, digital technologies have been increasingly adopted by consumers. This adoption has accelerated to wide availability of network technologies such as broadband Internet access and wireless networking. These technologies enable devices to interact with each other as well with a global community of users and businesses. As such, devices large and small are increasingly network aware.

Increased usage of digital entertainment has led users to demand greater device interoperability, so that content such as video, audio, and pictures, audio can be easily shared by devices throughout the home. However, consumers too often find out that network-capable devices are not necessarily compatible with each other or with the consumer's home networking equipment. This interoperability requires that the devices not only use compatible data transfer media and protocols, but that the media itself is in a format usable by all of these devices.

In response to these demands, a number of consumer electronics manufacturers formed an organization known as the Digital Living Network Alliance (DLNA). The goal of the DLNA is ensure device and content interoperability throughout the home using established industry standards. For example, to ensure device interoperability, the DLNA incorporates standards from such bodies as the Internet Engineering Task Force (IETF), the World Wide Web Consortium (W3C), and the Universal Plug and Play (UPnP) Forum. For example, the device model used by DLNA is derived from the UPnP framework.

The UPnP Forum defines an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages IETF and W3C standards such as Transmission Control Proto/Internet Protocol (TCP/IP) and Hypertext Markup Language (HTML) to enable seamless proximity networking in addition to control and data transfer among networked devices.

In addition to connectivity standards, the DLNA incorporates media standards such as JPEG, LPCM, and MPEG2 for rendering digital image, audio, and video respectively. The focus on media formats is a distinguishing feature between the work of the UPnP Forum and DLNA. The UPnP framework was designed with a focus on ensuring devices can discover each other's services and utilize those services across the network. However, it is up to the peer UPnP devices to determine/negotiate compatible media formats outside of the UPnP framework. Thus the DLNA media profiles are intended to fill that gap.

Numerous media profiles with specific DLNA media profile identifiers have been defined to help devices ensure media format compatibility. When a DLNA device creates the content (e.g., digital camera) this can ensure that the content is digitized and stored in a DLNA compatible from the start. However, user will want to incorporate legacy media files into their DLNA network, and may also want to transfer/incorporate media from devices that are not fully DLNA certified. As a result, when a DLNA device such as a media server adds new content (e.g., media file, link to content), the device may need to analyze the content and assign a DLNA media profile identifier to each item of content.

Determining media profile identifiers for unknown content may be processor intensive. Such determination may involve guessing a format (e.g., via a file name extension), examining content headers, and/or analyzing samples of the digitized content, using media codecs to resolve images, etc. As such, devices with less powerful processors (e.g., mobile devices) may see performance issues when trying to determine media profile identifiers for locally accessible content. However, with the increased capacity seen in portable devices such as media players and mobile phones, it becomes more likely that users will want to use such mobile devices as a primary media storage to ensure their media is always close at hand. However, when a large amount of new content is being added to a mobile device (e.g., initial deployment, when the user desires to change hundreds or thousands of media content items) the user experience may significantly suffer if the processing takes too long time. Thus, improving the performance of DLNA media profile characterization in such devices is desirable.

### SUMMARY OF THE INVENTION

To overcome limitations in the prior art described above, and to overcome other limitations that will become apparent upon reading and understanding the present specification, the present invention discloses a system, apparatus and method for assisting media server devices in determining media profiles. In one embodiment, a method involves enumerating digital media objects on a media server device. A remote procedure call of a network server is invoked to determine media profile identifiers of the digital media objects, and sample portions of the digital media objects are accessed. The sample portions are usable to assign the media profile identifiers to the respective digital media objects. The sample portions of the digital media objects are sent to the network server and, in response to invoking the remote procedure call, the media profile identifiers assigned to the sample portions are received from the network server. Based on the assignment of the media profile identifiers to the sample portions, the media profile identifiers are assigned to the digital media objects at the media server device.

In a more particular embodiment of the method, the media profile identifiers include Digital Living Network Alliance (DLNA) media profile identifiers. In one variation, sending the sample portions of the media files involves sending the sample portions of the media files as an argument of the remote procedure call. In such a variation, the sample portions of the media files may be sent as binary objects embedded in an Extensible Markup Language (XML) document. In another variation, the method may further involve discovering the remote procedure call via a service discovery protocol of a home network.

In a more particular embodiment of the method, invoking the remote procedure call involves sending Uniform Resource Identifiers (URIs) of the digital media objects as an argument of the remote procedure call. In such a case, sending the sample portions of the media files may involve sending the sample portions of the media files by a media access service of the media server device in response to a client request made by the network server. Further in such a case, the client request is made in response to invoking the remote procedure call, and the client request includes the URIs of the digital media objects. The client request may be made via a Hypertext Transport Protocol (HTTP) method, and the sample portions may be defined in the HTTP method by the use of an HTTP Range header.

In another embodiment of the invention, an apparatus includes a network interface capable of connecting to a network server via a home network and a processor coupled to the network interface. Memory is coupled to the processor, and the memory includes a media server that provides access to digital media objects stored on the apparatus. The memory further includes instructions that cause the processor to enumerate the digital media objects and invoke a remote procedure call of the network server to determine media profile identifiers of the digital media objects. The instructions further cause the processor to access sample portions of the digital media objects. The sample portions are usable to assign the media profile identifiers to the respective digital media objects. The instructions further cause the processor to send the samples of the digital media objects to the network server via the home network and receive from the network server the media profile identifiers assigned to the sample in response to invoking the remote procedure call. The processor assigns the media profile identifiers to the digital media objects based on the assignment of the media profile identifiers to the samples.

In another embodiment of the invention, an apparatus includes a network interface capable of connecting to a media server device via a home network. A processor is coupled to the network interface and memory is coupled to the processor. The memory includes instructions that cause the processor to receive, via the home network, a request to invoke a remote procedure call to assign media profile identifiers to respective digital media objects that are accessible via the media server. The instructions further cause the processor to access sample portions of the digital media objects from the media server device, analyze the sample portions to assign media profile identifiers to the respective digital media objects, and send the media profile identifiers to the media server device in response to the request.

In another embodiment of the invention, a system includes: means for enumerating digital media objects on a media server device; means for defining sample portions of the digital media objects, wherein the sample portions are usable to assign media profile identifiers to the respective digital media objects; means for receiving, via a home network, a request to assign the media profile identifiers to the respective digital media objects; means for analyzing the sample portions to assign media profile identifiers to the respective digital media objects; and means for sending the media profile identifiers to the media server device in response to the request.

In another embodiment of the invention, a computer readable storage medium has instructions stored thereon that are executable by a processor to: enumerate digital media objects accessible via a network media server device; invoke, via a home network, a remote procedure call of a network server to determine media profile identifiers of the digital media objects; access sample portions of the digital media objects, wherein the sample portions are usable to assign the media profile identifiers to the respective digital media objects; send the samples of the digital media objects to the network server via the home network; receive from the network server the media profile identifiers assigned to the sample in response to invoking the remote procedure call; and assign the media profile identifiers to the digital media objects based on the assignment of the media profile identifiers to the samples.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIGS. 2-3 are sequence diagrams illustrating media profiling according to various embodiments of the invention;

FIG. 4 is a block diagram of a media profiling service apparatus according to an embodiment of the invention;

FIG. 5 is a block diagram of a client device that utilizes a media profiling service according to an embodiment of the invention; and

FIG. 6 is a flowchart describing procedures according to an embodiment of the invention.

### DETAILED DESCRIPTION OF EMBODIMENTS OF THE INVENTION

In the following description of various embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present disclosure is related to efficiently and automatically characterizing digital media on mobile devices. For example, a mobile device capable of acting as a media server may create a (relatively small) sample of stored/accessible digital media, and send this sample to a network server for analysis and characterization. The sample is chosen with the smallest size possible, while still having enough data to enable characterization of the media from which the sample is taken. This characterization may, for example, result in a DLNA media profile identifier (ID) being assigned to the media from which the sample was taken.

The embodiments described herein provide advantages in some cases, such as where media is stored/served via mobile devices. In such cases, embodiments of the invention allow faster detection of profile IDs when large number of files will be examined. Offloading of profile detection can improve mobile device performance, decrease waiting times, and decrease battery usage. Such profile detection may also work in concert with media re-coding or transcoding services to change mobile content to DLNA-compatible formats. This may be useful in situations where commonly used mobile device formats are not DLNA compatible, thereby preventing the media and/or device from taking advantage of DLNA certification. In addition, if DLNA capabilities are extended/modified, it may be simpler to update software on single computing device than in a number of mobile and/or embedded devices. As a result, a system can be more easily kept up to date on the current DLNA capabilities.

In some embodiments described herein, some of the interactions may use service discovery mechanisms of ad-hoc, peer-to-peer networks. A widely implemented form of this network technology is UPnP, which is promoted by the UPNP Forum. The UPnP Forum promises transparent communication between any type of network-capable appliance, machine, or device. In many examples that follow, the use of UPnP and related technologies is illustrated with respect to audio-video (AV) components, although the concepts may apply equally to any type of apparatus.

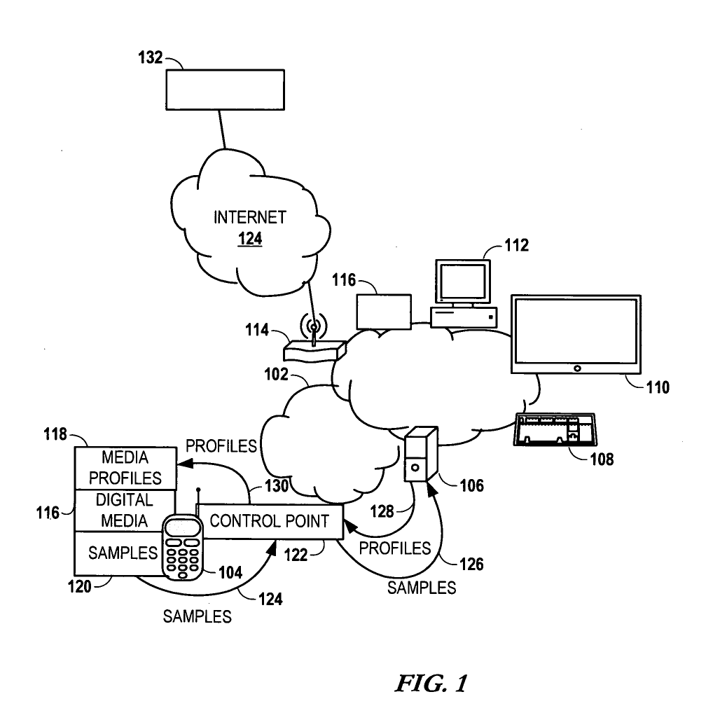

In reference now to FIG. 1, a block diagram shows a system according to an embodiment of the invention. Generally, a local network 102 couples a number of computing apparatuses, including mobile device 104 (e.g., mobile communication device, audio/video player, digital camera/camcorder, positioning/navigation device, game device, television), media server 106 (e.g., personal computer, server, set-top box, storage device, or digital video recorder), input device 108 (e.g., keyboard), media renderer 110 (e.g., television, projector, audio player), personal computer (PC) 112, router/gateway/wireless access point 114, and sensors 116 (e.g., movement, temperature, humidity, audio, still/video camera).

The local network 102 may be suited for encompassing a physical space suitable for a home or small office application, as well as dealing with a (sometimes small) quantity of devices that might be seen in home or small business environment. Such a local network 102 may also be adaptable for use in other user environments, such as industrial computing/automation, vehicle/automotive computing or mobile/wearable computing. Additionally, the network 102 may encompass other physically distant networks (e.g., in vehicles, summer homes) by using Virtual Private Networking (VPN) via the Internet 124 or similar remote access technologies.

Devices coupled to the network 102 may utilize one or more protocols for service discovery. As described above, the network 102 may use service discovery protocols associated with DLNA, such as UPnP. Other wired and/or wireless protocols and technologies may also be adaptable to enable computing and non-computing devices to interoperate via the network, including Bonjour, Zeroconf, Jini™, X10, Bluetooth, xAP, Rendezvous, HomeRF, IrDA, Local Area Network (LAN), Wireless LAN (WLAN), WiFi, Ultra Wide Band (UWB), WiBree, Intelligent Grouping and Resource Sharing (IGRS), etc. Generally, these protocols and technologies may make enable various devices to exchange digital media for use/rendering.

In the illustrated network, mobile device 104 includes stored digital media content 116. In order to for the device 104 to share this media content 116 with DLNA-certified components (or in analogous systems) the mobile device 104 may need to obtain or compile media profile data 118. The media profile data 118 may describe a number of aspects of the underlying media objects 116, such as encoding (e.g., codec, version, bitrate, variable/fixed bit rate scheme), digital rights management (e.g., encryption, licenses, permissions), and other metadata (e.g., file extensions, file size, date created/modified/accessed, etc.). In the embodiments described hereinbelow, the media profile data 118 may take the form of a DLNA profile ID, Multipurpose Internet Mail Extensions (MIME) types, and UPNP Audio Video (AV) class information (e.g., as defined in ContentDirectory: 1 specification) and file extension.

At some during or after the digital media content 116 is transferred to the device 104, a number of representative samples 120 are created. These samples 120 may created by the device 104 itself, or by some other device (e.g., source device that sends the media to device 104) and may be dynamically generated and/or stored with the media content 120. The samples 120 may be defined so that the samples 120 may be extracted using minimal processing. For example, the samples 120 may be formed from a fixed and/or easily calculated leading and/or trailing bits of a file. In other arrangements, the samples 120 may be formed by reading the files from the beginning until a certain pattern is detected. In configurations where the samples 120 includes an unmodified excerpt of the underlying, locally stored content 116, then it may not be needed to separately store the samples on the device 104, because the samples are already stored in the form of the media. In other cases, the media content 116 may be remotely stored (e.g., the device 104 uses a Uniform Resource Locator to access remote digital content) then there may be some benefit in locally storing samples 120 on device 104.

The samples 120 may be sent to other elements of the network 102 by way of a control point component 122. The control point 122 generally directs interactions between source and target devices on the network. For example, the control point 122 can be used for such operations as directing media from media storage devices (e.g., devices 104, 106) to media rendering devices (e.g., device 110). In this example, the control point 122 is directing the samples 120 be sent from device 104 to media server 106, as indicated by paths 124, 126. The control point 122 may operate on the device 104 or elsewhere on the network 102. For example, the control point 122 may be located on a mobile device, and/or on a home media server 106 that actively collects media content. In the latter case, the home media server 106 could use the server's own profile services to determine the profile IDs and then upload the content to mobile device 104.

The media server 106 (or similar device) may have much greater computational power than the mobile device 104, so in some scenarios the sample data 120 can be transferred 126 to the server 106 for purposes of characterizing the samples. Such characterization may be for purposes of determining media-descriptive data such as DLNA profile ID, MIME-types, and UPNP AV class information of the associated media content 116. This profile data is determined using up-to-date signatures and characterization software that may in some cases be more available on a fixed infrastructure machine 106 than portable device 104. The profile data is returned to device 104 as indicated by paths 128, 130.

The paths 124, 126, 128, 130 indicate that the control point 122 is an intermediary in transferring the samples and profiles between to the server 106 and device. However, the actual data transfer may occur independently of the control point 122 (e.g., via a path directly between the device 104 and media server 106). For example, the control point 122 may operate on a third device on the network 102. In such a case the control point 122 may provide enough data to one or more of the devices 104, 106 to allow the devices 104, 106 themselves to exchange data indicated bypaths 124, 126, 128, 130.

The system shown in FIG. 1 may include a number of variations. For example instead of the digital media 116 residing directly on device 104, it may be stored elsewhere, such as Internet server 132. In such a case, the device 104 and or control point 122 can send a listing of Uniform Resource Locators (URLs) that describe where the content is located, and the media server 106 can access the media via the Internet server 132, and thereby determine the profile data. This profile data may still sent 128, 130 for storage at device 104 and is thereafter associated with the URL. In such a way, the device 104 can serve as a conduit for the Internet server 132 to provide the content along with media profile data 118 that ensures operability on the network 102.

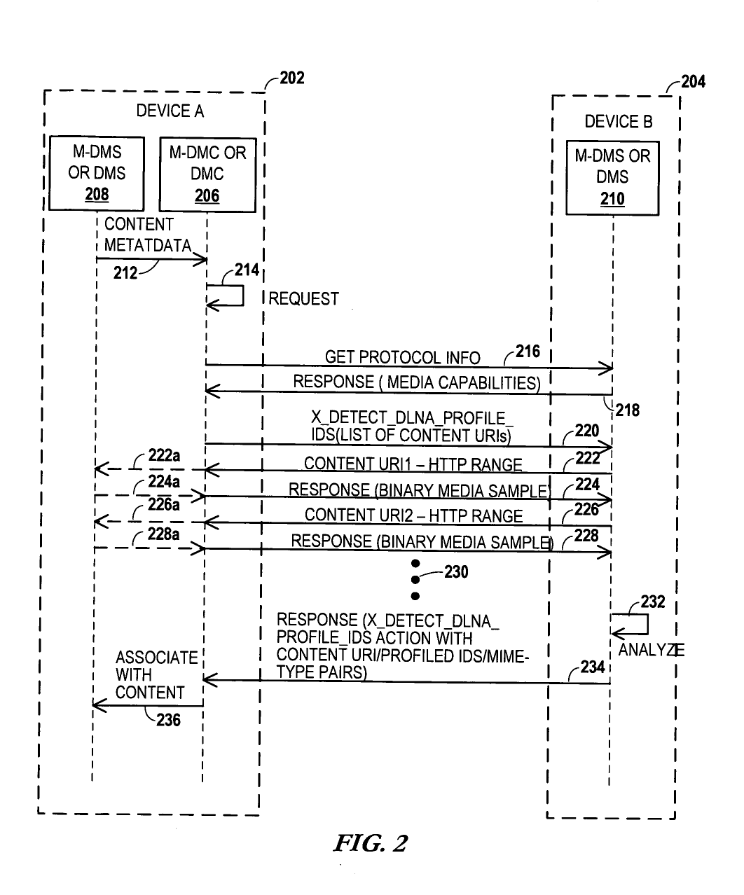

In reference now to FIG. 2, a sequence diagram illustrates a sequence of interactions in a system according to an embodiment of the invention. In this invention, the system includes first and second DLNA compatible devices 202, 204 that may be coupled via a network or other data coupling. The first device 202 includes a control point 206 that may be configured as a DLNA Digital Media Controller (DMC) and/or Mobile DMC (M-DMC). Similarly, the device 202 includes a media server 208 that may be configured as a DLNA Digital Media Server (DMS) of Mobile-DMS (M-DMS). The second device 204 also includes a media server 210 (e.g., M-DMS/DMS).

The first device 202 utilizes a service of the second device 204 for characterizing media stored on the first media server 208. The control point 206 may have access to metadata 212 that at least describes the availability of content available on the server 208. This metadata 212 may be accessed at any time needed by the control point 206, and here in this example as being received before a request 214 is made to characterize the content stored in or accessible by the media server 208. This request 214 may be generated in response to some internal event (e.g., adding of media to server 208), user generated event (e.g., request via user interface of device 202 to connect to DLNA network), and/or a network generated event (e.g., service discovery message transmitted on a DLNA network).

In order to satisfy the request 214, the control point 206 invokes a GetProtocolInfo action 216 (e.g., via remote procedure call to invoke a method across a network) to determine the media resolving capabilities of device 204. In response, the media server 210 of device 204 returns a description 218 (e.g., UPnP service description) of the device's capability to resolve media characteristics. After determining that the service is compatible, the control point 206 invokes a remote method 220 that causes the detection to commence.

The method 220 in this example is called “X_detectDLNAProfileIDs” and a list of content Uniform Resource Identifiers (URIs) are provided as arguments to the method 220. The URIs may be locally available at the control point 206 or may be obtained by querying the media server 202 (e.g., receiving response 212 in response to a query). An example of argument given with detectDLNAProfileIDs action 220 is shown below in Table 1:

TABLE 1

```
<List_Of_ContentUris>
  <ProfileID>ContentUri =
  “http:\\uri_to_the_content1.mp3”</ProfileID>
  <ProfileID>ContentUri =
  “http:\\uri_to_the_content2.mp3”</ProfileID>
  <ProfileID>ContentUri =
  “http:\\uri_to_the_content3.mp3”</ProfileID>
  <ProfileID>ContentUri =
  “http:\\uri_to_the_content4.mp3”</ProfileID>
  <ProfileID>ContentUri =
  “http:\\uri_to_the_content5.mp3”</ProfileID>
  <ProfileID>ContentUri =
  “http:\\uri_to_the_content6.mp3”</ProfileID>
  <ProfileID>ContentUri =
  “http:\\uri_to_the_content7.mp3”</ProfileID>
  <ProfileID>ContentUri =
  “http:\\uri_to_the_content8.mp3”</ProfileID>
</List_Of_ContentUris>
```

The illustrated media server 210 utilizes the Hypertext Transport Protocol (HTTP) “Range” header to obtain samples of media referenced by the URIs provided in the method invocations 220. Thus the server invokes 222, 226 an HTTP method (e.g., GET, POST) and uses the Range headers to define what portion of the target URIs should be returned as representative samples 224, 228. The range values used in the headers may be predetermined for some or all media types (e.g., as determined or guessed by filename extensions in the URI), may be communicated or hinted at by the control point 208 as part of method call 220, and/or may be adjusted as needed. For example, if sample 224 using a predetermined range cannot be used to positively characterize the content item associated with URI of method call 222, the media server 210 could make additional invocations of the method 222 using the same URI, but with different ranges to obtain additional content samples 224.

Although two examples of content access methods 222, 226 are shown, it will be appreciated that any number of invocations may be used, e.g., one for each content item represented by a URI in method call 220. This is indicated by ellipsis 230. Other adaptations may be used to reduce the number of repeated invocations 222, 226 used to obtain content samples. For example, the method call 220 could return a content URI such as “http://content-group.mp3.xml” which is an internal reference or document of device 202 that may, for example, provide access all of the media objects shown in Table 1.

When the media server 210 invokes a content retrieval method (e.g., 222) using the special internally significant URI that references a plurality of media objects, the device 202 may return 224 a multi-part message in response. The multi-part message includes a sample of each media item referenced by the special URI. The definition of the returned samples (e.g., size) could also be defined internally by this special URI, or a Range header value used in the method 222 could be applied to all of the samples. In this way, the overhead associated with multiple invocations of HTTP methods may be reduced. Other techniques may be used to extract multiple content samples using a single HTTP method call, such as executing a server side executable (e.g., common gateway interface script, active server page, Java™ Servlet, etc.) to dynamically generate the return samples as a multipart response or some other document.

The access methods 222, 226 and associated responses 224, 228 are shown in FIG. 2 as occurring between the control point 206 and media server 210. However, it will be appreciated that the media server 210 may obtain content from the content-storing media server 208, either directly or indirectly via control point 206. For example, the control point 206 may act as a proxy for the co-located media server 208, or the media server 208 may be directly addressed by server 210. These interactions with the media server 208 are indicated by broken lines 222a, 224a, 226a, and 228a.

After obtaining media samples, the device 204 analyzes 232 the samples to determine, for example, DLNA Profile IDs, UPnP AV class, and/or MIME types. The device 204 then returns the results 234 as response to the invocation 216. The device 204 can then use the returned data 234 for purposes of characterizing the media, such as storing 236 the data at the media server 208 for purposes of interacting on a DLNA network. Table 2 lists an example of data that may be contained in response 234 for the URIs listed in Table 1.

```
TABLE 2
<List_Of_ContentUris>
  <ProfileID>ContentUri = “http:\\uri_to_the_content1.mp3” mime-
    type = “mime_type1” file_ext = “ext1”ProfileID1</ProfileID>
  <ProfileID>ContentUri = “http:\\uri_to_the_content2.mp3” mime-
    type = “mime_type2” file_ext = “ext2”ProfileID2</ProfileID>
  <ProfileID>ContentUri = “http:\\uri_to_the_content3.mp3” mime-
    type = “mime_type3” file_ext = “ext3”ProfileID3</ProfileID>
  <ProfileID>ContentUri = “http:\\uri_to_the_content4.mp3” mime-
    type = “mime_type4” file_ext = “ext4”ProfileID4</ProfileID>
  <ProfileID>ContentUri = “http:\\uri_to_the_content5.mp3” mime-
    type = “mime_type5” file_ext = “ext5”ProfileID5</ProfileID>
  <ProfileID>ContentUri = “http:\\uri_to_the_content6.mp3” mime-
    type = “mime_type6” file_ext = “ext6”ProfileID6</ProfileID>
  <ProfileID>ContentUri = “http:\\uri_to_the_content7.mp3” mime-
    type = “mime_type7” file_ext = “ext7”ProfileID7</ProfileID>
  <ProfileID>ContentUri = “http:\\uri_to_the_content8.mp3” mime-
    type = “mime_type8” file_ext = “ext8”ProfileID8</ProfileID>
</List_Of_ContentUris>
```

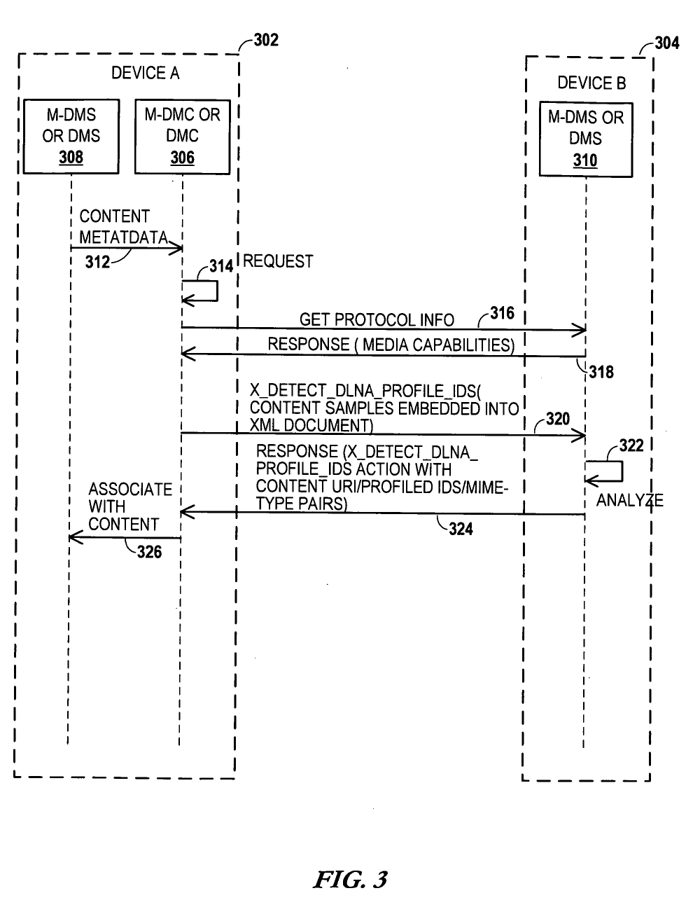

In reference now to FIG. 3, a sequence diagram illustrates a sequence of alternate interactions in a system according to an embodiment of the invention. Similar to FIG. 2, first and second DLNA compatible devices 302, 304 communicate, e.g., via a network. The first device 302 includes a control point 306 (e.g., DMC/M-DMC) and media server 308 (e.g., DMS/M-DMS). The second device 204 also includes a media server 210 (e.g., M-DMS/DMS).

The first device 302 utilizes a service of the second device 304 for characterizing media stored on the first media server 308. The control point 306 has access to metadata 312 that at least describes the availability of content available on the server 308. In this scenario, the metadata 312 may also include samples of media server content that are accessed directly by the control point 306. This metadata 312 may be accessed at any time needed by the control point 306, and here in this example as being received before a request 314 is made to characterize the content stored on or accessible by the media server 308. This request 314 may be generated in response to some internal event, user generated event, and/or a network generated event.

As with the scenario in FIG. 2, the control point 306 in FIG. 3 discovers the media resolving services of the media server via a GetProtocolInfo action 316 returns a response 318. After determining that the service is compatible, the control point 306 invokes a method 320 (e.g., X_detectDLNAProfileIDs) to cause the detection to be carried out. Unlike the scenario in FIG. 2, the invocation of the X_detectDLNAProfileID 320 in FIG. 3 involves the passing of the samples in the method invocation 320 itself, such as by inserting binary samples in an XML document. This enables the media server 310 to analyze 322 the samples and return the result 324 without requiring any intermediary communications between the media servers 308, 310. The device 302 can make use of the received profile data 324, such as by storing and associating the profiles with the content at the media server 308.

Note that the embedding of the samples in the method invocation 320 may require that the control point 306 and/or media server 308 know beforehand the correct sample size and composition. This data may be known by the control point 306, or may be communicated to the control point 306 by the media server 310 via service discovery response 318, or by another method invocation for specifically for that purpose (not shown). In another variation, the profile data 324 may also include error codes that indicate that some samples could not be profiled, and could contain hints (e.g., different sample size/composition) that might be use to re-invoke 320 the service.

In the examples described above, a home media server may be implemented an X_detectDLNAProfileIDs( ) action as part of a UPnP Content Directory Service (CDS). This CDS Profile ID service takes media samples as input, determines the DLNA profileID (and another other relevant data, such as MIME-type and file extensions) and returns all profile IDs in one or more XML files. The input to the CDS Profile ID service can also be URL that is used to fetch media samples directly. This operation can be in background, such as when a remote device is locally coupled to a home network. The operation can also be operated remotely, such as where a user device access the home network using Network Address Translation (NAT) pass-through or a Virtual Private Network (VPN).

A control point can be used to find out services for media profile detection and facilitates moving files between two servers as part of this detection. Note that the device that utilizes a Profile ID service to characterize media need not directly store the media on the device. For example, a media server may store a URI to an Internet radio station that is accessed by the user in the same way as a locally stored file. This Internet URI could be used to capture metadata associated with the media stream, or take a sample of the stream itself. This data is passed to the Profile ID service to assist in characterizing the media stream. The profile could be stored on the local hosting device and used whenever a local component accesses the Internet stream via the local hosting device.

As described above, a network service may be implemented for automatically determining, for a particular device, profiles of media stored on or accessible via the particular device. Such service may be implemented in the UPnP framework and used to determine DLNA profiles of the target media. A control point, possibly in a mobile phone or PC, pushes the collection of media samples to a media server. The media server returns list of respective media profile IDs. In addition to determining DLNA profileIDs, the server may also determine and assign any combination of MIME-type, UPnP AV class info (defined by ContentDirectory: 1 spec) and file extensions to the media.

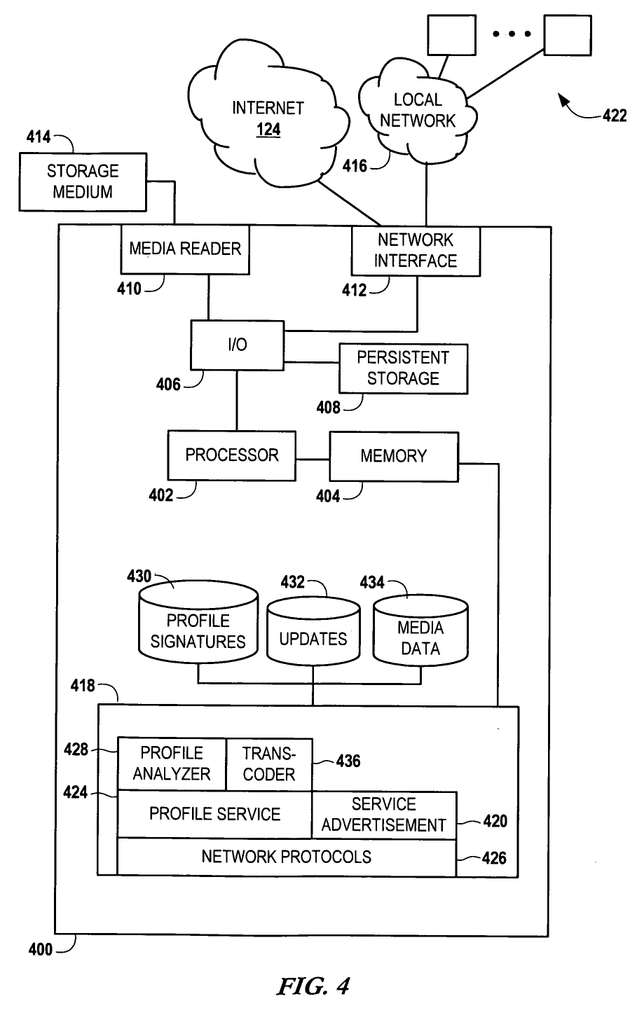

In reference now to FIG. 4, a block diagram illustrates an apparatus 400 that, in one embodiment of the invention, that may be configured to perform remote media profiling. The apparatus 400 includes a processor 402, memory 404, and an I/O bus 406 that couples peripheral devices to the processor 402. The peripheral devices coupled via the I/O bus 406 may include persistent memory storage 408 (e.g., disc drives, flash memory), one or more network interfaces 412, and a media reader 410 (e.g., tape reader, floppy drive, Compact Disc player, Digital Versatile Disc player, memory card reader, etc.).

The media reader 410 is capable of reading from a storage media 414, such as optical or magnetic media. The media reader 410 may also be capable of writing to the media 414. The network interfaces 412 may be capable of communicating via one or more local networks 416 and the Internet 124. The local network 416 may utilize such media such as phone lines, coaxial cable, Ethernet, wireless radio transmissions, infrared transmissions, etc. The network 416 may include Internet Protocol (IP) based public and private networks, as well as proximity networking such as Bluetooth, WLAN, UWB, WiBree, and IrDA. The local network 416 may also utilize higher-level protocols for ad-hoc peer-to-peer connectivity, such as UPnP, Zeroconf, Jini™, and may include one or more DLNA compatible devices 422.

The operation of the processor 402 is dictated by instructions 418 that may be stored temporarily or permanently in memory 404 or other logic circuitry. The instructions 418 may be built into to the apparatus 400 during manufacture, or may be later transferred to the apparatus 400 via the storage media 414 or the networks 416. The instructions 418 may include one or more peer-to-peer service advertisement modules 420 capable of advertising a media profiling service 424 to other devices 422 of the network 416. The service advertising module 420 may operate over any current or future service discovery protocols, including UPnP service discovery in compliance with the DLNA certification. The service advertisement module 420 and profile service 424 may rely on a standard networking protocol stack 426 for common network protocols such as TCP/IP, UDP/IP, etc. The network protocol stack 426 in turn utilizes the network interface 412 for accessing the network(s) 416, 124.

The profile service 424 may include an interface, e.g., a Web Services Interface or network Application Programming Interface (API), with methods that can be invoked by network devices 422. The profile service 424 receives requests for profile analysis from the devices 422, and in response, gathers samples of media stored on or accessible by the devices 422. The profile service 424 includes/uses a profile analyzer component 428 that analyzes the collect samples to determine an appropriate categorization, such as a DLNA Profile ID and/or MIME type. The categorization data determined by the analyzer 428 is sent back to the devices 422 in response to the request for profile analysis.

The profile service 424 and analyzer 428 may utilize a database 430 for accessing signatures that assist in determining profiles. These signatures 430 may be similar to signatures used to detect computer viruses, e.g., comparing signatures to the samples to look for characteristic byte patterns. Although the signature database 430 may be stored locally, it may also be accessed wholly or in part via the Internet 124 and other remote networks. The signature database 430 (and other system components) may utilize a local (or remote) update database 432 that can be used to maintain currency of such data as signatures 430, DLNA standards, etc.

The apparatus 400 may provide the profile service 424 on an as-needed basis, and independently of other operations of the apparatus 400. In other cases, the data derived from the invocation of the service 424 may have other utilities that can be put to use by the apparatus 400. For example, the apparatus 400 may be a media server that provides media to other devices, such as via the DLNA and/or UPnP frameworks. The apparatus 400 may include locally stored media data 434 in accordance with this media server function. In such a configuration, the profile service 424 and/or analyzer 428 may store data (e.g., URIs) of analyzed media content in the media database 434 along with locally stored media. In this way, the apparatus 400 may be enabled to automatically function as a proxy for the devices 422 that invoke the service 424. The apparatus 400 can advertise the media of devices 422 in its own content listings, and redirect content requests to the appropriated devices 422 and/or cache and serve the content from the local storage 434.

In some situations, the profile analyzer 428 may be able to recognize a particular type of media based on a received sample, but determine that the format is incompatible with the database of compatible media signatures 430. This could be indicated in an error code returned by the service 424 to the requesting device. However, it may also be possible for the apparatus 400 to put the media object in a compatible format by transcoding the object, as indicate by transcoder 436. In such a case, the profile service 424 or some other component (e.g., control point of the service requesting device) may indicate to the user that conversion of media objects may be needed. Upon user confirmation (if needed based on configuration settings), the profile service 424 can download the full media object, process it via the transcoder 436, and send the transcoded object back to the requesting device, along with a profile identifier corresponding to the new coding format. In this way, the service 424 can offload another process-intensive task from the requesting device, namely the transcoding of media.

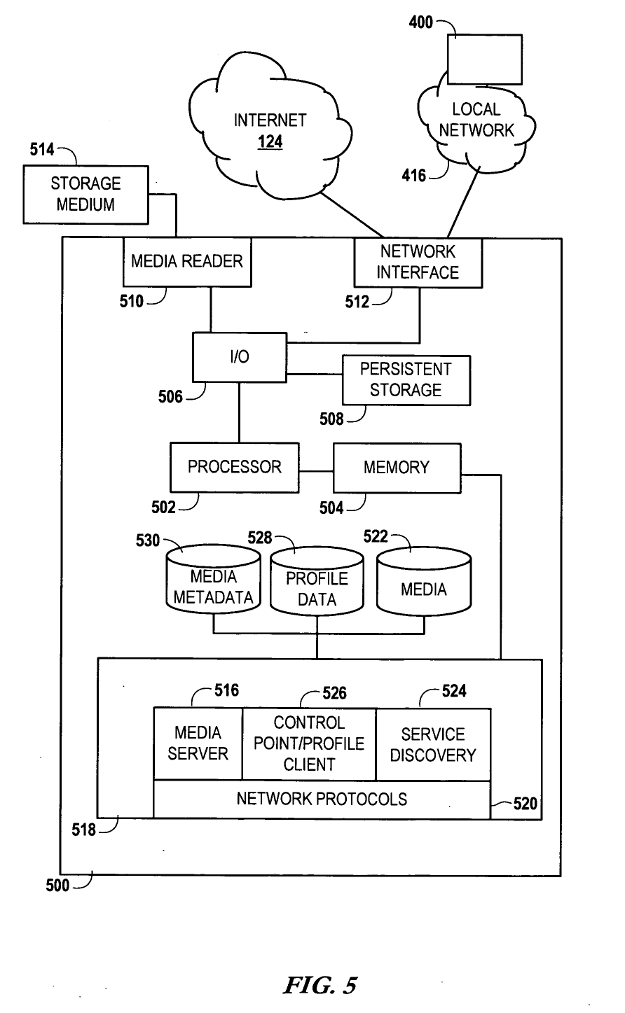

As described above, a network service component may be implemented that automatically determines profiles of media stored on network devices. This service may be useful, e.g., for mobile devices that may have limited processing power and/or limited ability to maintain up-to-date profile data. In reference now to FIG. 5, a block diagram illustrates an apparatus 500 that may access a profile service according to embodiments of the invention. The apparatus 500 may include a processor 502, memory 504, and an I/O bus 506 that couples peripheral devices to the processor 502. Those peripheral devices may include persistent memory storage 508, one or more network interfaces 512, and a media reader 510. The media reader 510 is capable of reading from a storage medium 514. The media reader 510 may also be capable of writing to the media 514. The network interfaces 512 may be capable of communicating with the Internet 124 and/or home networks 416 such as described in relation to FIG. 4.

The operation of the processor 502 is dictated by instructions 518 that may be stored temporarily or permanently in memory 504 or other logic circuitry. The instructions 518 may be built into to the apparatus 500 during manufacture, or may be later transferred to the apparatus 500 via the storage media 514 or the networks 416, 124. The instructions 518 may include one or more networking protocol stacks 520 for common network protocols such as TCP/IP, UDP/IP, 512 for accessing the networks 416, 124 via network interface 512. The protocol stacks 520 may also be used for application-level network protocols, such as UPnP, Zeroconf, HTTP, etc.

The apparatus 500 may operate as a media server, as indicated by media server module 516 and stored media 522. The media server 516 may include the functionality defined for a DLNA M-DMS/DMS and/or be compatible with other ad-hoc, peer-to-peer digital media utilization technologies. The instructions 518 include a service discovery module 524 that can discover a media profiling service, such as provided by server apparatus 400 on local network 416, as described in greater detail in relation to FIG. 4. A control point/profile client 526 may include the ability to determine available services via the service discovery module 524, accept user inputs to use discovered services, accept triggers from other programs to use discovered services, utilize discovered services (e.g., invoke remote methods), communicate results to the user and other functional components, etc. The control point/profile client 526 may be an integrated components specialized for using the media profiling services, or may be included as an extension (e.g., plug-in) to existing generic control point modules.

The control point/profile client 526 may be capable of determining the composition of stored media 522, such as by local filesystem access/enumeration, network directory services (e.g., UPNP ContentDirectory), etc. This may involve the access/creation of metadata 530 that describes the media. The metadata 530 may include data of interest to the underlying operating system and software (e.g., file names, file locations, file size, dates added/modified) and to the user (e.g., title, artist, playing time, etc.). However, in order to successfully share the media 522 with other devices of the network 416, the media server 516 may need other data, here shown as stored profile data 528. The profile data 528 may include data associated with media 522 that enables determining compatibility with standards in use on the network. Such data may include bitrate, codecs, DRM, etc., and be in the form of DLNA Profile IDs, MIME-types, UPnP AV class, and/or file extensions.

The control point/profile client 526 accesses a network service (e.g., via apparatus 400) for building and maintaining the profile data 528. This may involve creating samples of the media, or providing access URIs to the media 522 so that an external device may extract its own samples (e.g., via HTTP Range headers). In response to the samples being made available to the network service, profiles that characterize the media are received by the control point/profile client 526 and stored in the database 528. It will be appreciated that the media data 522, 528, 530 maybe maintained by any combination of local and remote databases, and may be included in the same or different physical media and database volumes/schema.

The apparatuses 400, 500 in FIGS. 4 and 5 may include other well-known features that are not illustrated, such as user input devices, user output devices, power circuitry, sensors, etc. As will be appreciated by one of skill in the art, an apparatus having the functions described herein may include a combination of two or more physical devices that are at least coupled via some data transfer medium to form a distributed computing arrangement. In other arrangements, the functions of various components represented by computing instructions 418, 518 can be separated to operate via dependently or independently operating computing arrangements coupled by networks. The devices 400, 500 may be configured as either fixed infrastructure devices requiring continuous utility power, or as mobile devices utilizing battery power and wireless network interfaces.

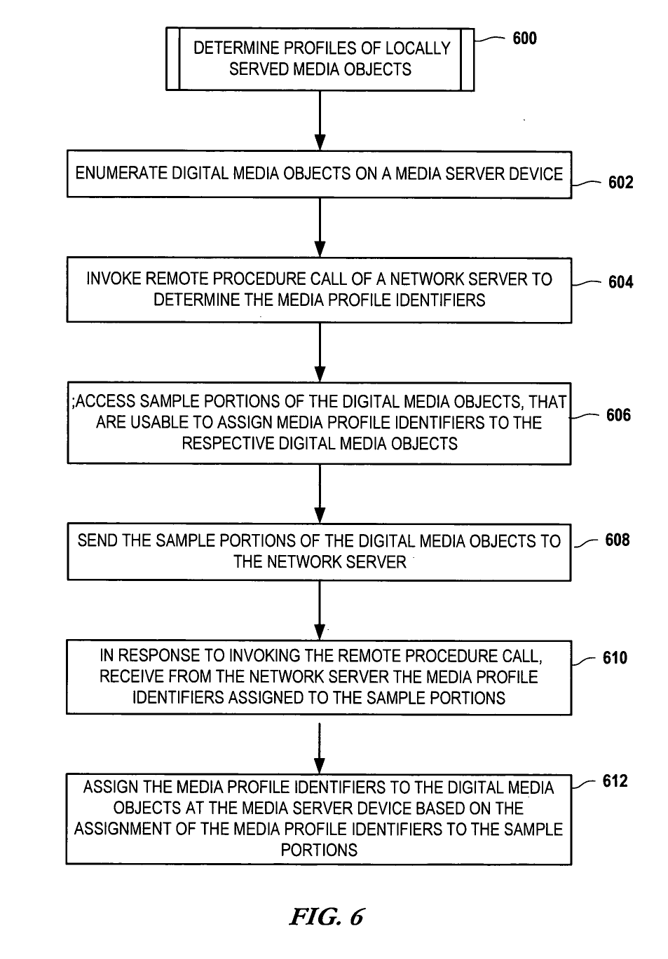

In reference now to FIG. 6, a flowchart 600 illustrates a procedure 600 for determining profiles of locally served media objects. The procedure 600 involves enumerating 602 digital media objects on a media server device. This may involve, for example, determining/gather file/URI metadata related to the objects. A remote procedure call of a network server is invoked 604 to determine the media profile identifiers. This may involve the use a network remote procedure call (RPC) mechanism, such as Simple Object Access Protocol (SOAP), Java Remote Method Invocation (RMI), and other RPC mechanisms known in the art.

Sample portions of the digital media objects are accessed 606. The sample portions are usable to assign media profile identifiers to the respective digital media objects. The sample portions may be accessed before, during, or after the invocation 604 of the RPC, and may be performed via the invoking media server device and/or the network server. The sample portions of the digital media objects are sent 606 to the network server. In response to invoking 604 the remote procedure call, the media server device receives 610 the media profile identifiers assigned to the sample portions from the network server. The media profile identifiers are assigned 612 to the digital media objects at the media server device based on the assignment of the media profile identifiers to the sample portions. Thereafter, the media profile identifiers may be used to characterize the media objects as required by the home network protocols.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
enumerating digital media objects on a media server device;
invoking a remote procedure call of a network server to determine media profile identifiers of the digital media objects;
accessing sample portions of the digital media objects, wherein the sample portions are usable to assign the media profile identifiers to the respective digital media objects;
sending the sample portions of the digital media objects to the network server;
in response to invoking the remote procedure call, receiving from the network server the media profile identifiers assigned to the sample portions; and
assigning the media profile identifiers to the digital media objects at the media server device based on the assignment of the media profile identifiers to the sample portions.

2. The method of claim 1, wherein the media profile identifiers comprise Digital Living Network Alliance (DLNA) media profile identifiers.

3. The method of claim 1, wherein sending the sample portions of the media files comprises sending the sample portions of the media files as an argument of the remote procedure call.

4. The method of claim 3, wherein the sample portions of the media files are sent as binary objects embedded in an Extensible Markup Language (XML) document.

5. The method of claim 1, wherein invoking the remote procedure call comprises sending Uniform Resource Identifiers (URIs) of the digital media objects as an argument of the remote procedure call.

6. The method of claim 5, wherein sending the sample portions of the media files comprises sending the sample portions of the media files by a media access service of the media server device in response to a client request made by the network server, and wherein the client request is made in response to invoking the remote procedure call, and wherein the client request includes the URIs of the digital media objects.

7. The method of claim 6, wherein the client request is made via a Hypertext Transport Protocol (HTTP) method, and wherein the sample portions are defined in the HTTP method by the use of an HTTP Range header.

8. The method of claim 1, further comprising discovering the remote procedure call via a service discovery protocol of a home network.

9. An apparatus comprising:
a network interface capable of connecting to a network server via a home network;
a processor coupled to the network interface; and
memory coupled to the processor, wherein the memory comprises a media server that provides access to digital media objects stored on the apparatus, the memory further comprising instructions that cause the processor to:
enumerate the digital media objects;
invoke a remote procedure call of the network server to determine media profile identifiers of the digital media objects;
access sample portions of the digital media objects, wherein the sample portions are usable to assign the media profile identifiers to the respective digital media objects;
send the samples of the digital media objects to the network server via the home network;
receive from the network server the media profile identifiers assigned to the sample in response to invoking the remote procedure call; and
assign the media profile identifiers to the digital media objects based on the assignment of the media profile identifiers to the samples.

10. The apparatus of claim 9, wherein the media profile identifiers comprise Digital Living Network Alliance (DLNA) media profile identifiers.

11. The apparatus of claim 9, wherein sending the sample portions of the media files comprises sending the sample portions of the media files as an argument of the remote procedure call.

12. The apparatus of claim 9, wherein invoking the remote procedure call comprises sending Uniform Resource Identifiers (URIs) of the digital media objects as an argument of the remote procedure call.

13. The apparatus of claim 12, wherein sending the sample portions of the media files comprises sending the sample portions of the media files by a media access service of the media server device in response to a client request made by the network server, and wherein the client request is made in response to invoking the remote procedure call of the network service, and wherein the client request includes the URIs of the digital media objects.

14. The apparatus of claim 13, wherein the client request is made via a Hypertext Transport Protocol (HTTP) method, and wherein the sample portions are defined in the HTTP method by the use of an HTTP Range header.

15. The apparatus of claim 9, wherein the instructions further cause the processor to discover the remote procedure call via a service discovery protocol of the home network.

16. An apparatus comprising:
a network interface capable of connecting to a media server device via a home network;
a processor coupled to the network interface; and
memory coupled to the processor, wherein the memory comprises instructions that cause the processor to:
receive, via the home network, a request to invoke a remote procedure call to assign media profile identifiers to respective digital media objects that are accessible via the media server;
access sample portions of the digital media objects from the media server device;
analyze the sample portions to assign media profile identifiers to the respective digital media objects; and
send the media profile identifiers to the media server device in response to the request.

17. The apparatus of claim 16, wherein the media profile identifiers comprise Digital Living Network Alliance (DLNA) media profile identifiers.

18. The apparatus of claim 16, wherein accessing the sample portions of the media files comprises receiving the sample portions of the media files as an argument to the remote procedure call.

19. The apparatus of claim 16, wherein the instructions further cause the processor to:
receive Uniform Resource Identifiers (URIs) of the digital media objects as an argument of the remote procedure call; and
make a client request to the media server to access the sample portions of the media files in response to the invocation of the remote procedure call, wherein the client request includes the URIs of the digital media objects.

20. The apparatus of claim 19, wherein the client request is made via a Hypertext Transport Protocol (HTTP) request, and wherein the sample portions are defined in the HTTP request by the use of an HTTP Range header.

21. The apparatus of claim 16, further comprising advertising, via a service discovery protocol of the home network, the remote procedure call.

22. A system comprising:
means for enumerating digital media objects on a media server device;
means for defining sample portions of the digital media objects, wherein the sample portions are usable to assign media profile identifiers to the respective digital media objects;
means for receiving, via a home network, a request to assign the media profile identifiers to the respective digital media objects;
means for analyzing the sample portions to assign media profile identifiers to the respective digital media objects; and
means for sending the media profile identifiers to the media server device in response to the request.

23. A computer readable storage medium having instructions stored thereon executable by a processor to:
enumerate digital media objects accessible via a network media server device;
invoke, via a home network, a remote procedure call of a network server to determine media profile identifiers of the digital media objects;
access sample portions of the digital media objects, wherein the sample portions are usable to assign the media profile identifiers to the respective digital media objects;
send the samples of the digital media objects to the network server via the home network;
receive from the network server the media profile identifiers assigned to the sample in response to invoking the remote procedure call; and
assign the media profile identifiers to the digital media objects based on the assignment of the media profile identifiers to the samples.
